(19) United States
(12) Patent Application Publication
(10) Pub. No.: US 2009/0165125 A1
(43) Pub. Date: Jun. 25, 2009

(54) SYSTEM AND METHOD FOR CONTROLLING USER ACCESS TO A COMPUTING DEVICE

(75) Inventors: Michael K. Brown, Fergus (CA); Michael S. Brown, Kitchener (CA); Michael G. Kirkup, Waterloo (CA)

Correspondence Address: BERESKIN AND PARR, 40 KING STREET WEST, BOX 401, TORONTO, ON, M5H 3Y2, CA

(73) Assignee: RESEARCH IN MOTION LIMITED, Waterloo (CA)

(21) Appl. No.: 11/960,433

(22) Filed: Dec. 19, 2007

(51) Int. Cl. G06F 7/04

(52) U.S. Cl. 726/21

(57) ABSTRACT

A system and method for controlling user access to a computing device (e.g. a mobile device). In some embodiments, access rights are provided to a user based on successfully verified authentication factors, even where the user is unable to provide all the authentication factors typically required for access to the computing device. In one broad aspect, one or more authentication factors are provided by a user, and are received and verified by a security module application residing and executing on the computing device. When less than all of the authentication factors that would typically be expected in authenticating a user for access to the computing device is received and successfully verified, a subset of the available access rights selected from a plurality of different pre-defined subsets of access rights is provided to the user. The specific access rights provided to the user are based on the successfully verified authentication factors.

### TECHNICAL FIELD

Embodiments described herein relate generally to computing devices that employ user authentication techniques, and more specifically to a system and method for controlling user access to the computing devices based on authentication data received from users.

### BACKGROUND

Access control systems on computing devices, and in particular mobile devices, have become increasingly important due to, for example, the widespread use of such devices and their increased use for both personal and business communications. Some access control systems may require a user to provide multiple authentication factors for user authentication, which may comprise authentication data from multiple sources and/or a physical element (e.g. passwords, biometric data, smart cards, personal identification numbers (PINs), security tokens). When the proper authentication factors are provided, a comprehensive set of access rights to the computing device may be granted to the user. For example, the granted access rights may allow the user to operate the computing device, and to execute applications or obtain access to other resources or data, available on the computing device or on a network accessible by the computing device.

### BRIEF DESCRIPTION OF THE DRAWINGS

For a better understanding of embodiments described herein, and to show more clearly how they may be carried into effect, reference will now be made, by way of example, to the accompanying drawings in which:

FIG. 1 is a block diagram of a mobile device in one example implementation;

FIG. 2 is a block diagram of a communication subsystem component of the mobile device of FIG. 1;

FIG. 3 is a block diagram of a node of a wireless network;

FIG. 4 is a block diagram illustrating further aspects of the mobile device of FIG. 1 in an example embodiment; and

FIG. 5 is a flow chart illustrating a method of controlling user access to a computing device in accordance with at least one example embodiment.

### DETAILED DESCRIPTION

In some instances, a user may be unable to provide all of the required authentication factors. For example, a user may forget a password or may not have a smart card readily available at the time that access to a computing device is desired. In some known systems, a user would be denied all access rights to a computing device if the user cannot provide all of the required authentication factors.

In another known system, access control measures implemented in a computer operating system (e.g. Windows™) may provide a user with a static and limited number of access rights through the use of a guest or anonymous account, which the user may employ if the user is unable to provide all of the required authentication factors. Users may login to the guest or anonymous account using a generic login and/or password that is not specifically associated with that user, and in some cases, a login and/or password may not be required. However, such guest accounts typically only grant the “guest” one very specific, restricted and static set of access rights. For example, a user who operates a computing device using a guest account might not be permitted to access network resources from the computing device.

At least some embodiments described herein are directed to a technique where access rights may be provided to a user based on successfully verified authentication factors that are received from the user, even where the user is unable to provide all of the authentication factors typically required for access to the computing device.

In a broad aspect, one or more authentication factors associated with a user are provided by the user, and are received and verified by a security module application residing and executing on the computing device. When less than all of the authentication factors that would typically be expected in authenticating a user for access to the computing device is received and successfully verified, a subset of the available access rights is selected from a plurality of different subsets of access rights and provided to the user. The specific access rights in the selected subset provided to the user are based on the successfully verified authentication factors.

In another broad aspect, there is provided a method of controlling access to a computing device, wherein in operation, m access rights associated with the computing device are provided only upon successful verification of n authentication factors, where m and n are integers greater than 1, the method comprising: receiving one or more authentication factors required for access to the computing device; verifying each of the one or more authentication factors received; if at least one authentication factor is successfully verified and the number of successfully verified authentication factors equals n, providing m access rights; and if at least one authentication factor is successfully verified and the number of successfully verified authentication factors is less than n, determining a selected subset of access rights from a plurality of different subsets of access rights, wherein the plurality of different subsets of access rights comprises more than one subset consisting of less than m access rights, and providing the selected subset of access rights.

In another broad aspect, a weight factor is associated with each of the n authentication factors, and the method further comprises: determining an access score to determine the selected subset, the access score being a function of the weight factors associated with the successfully verified authentication factors, wherein the selected subset of access rights is determined based on the access score.

In another broad aspect, when the number of successfully verified authentication factors is less than n, the selected subset of access rights is determined based on the number of successfully verified authentication factors.

In another broad aspect, when the number of successfully verified authentication factors is less than n, the selected subset of access rights is determined based on the type of at least one successfully verified authentication factor.

In another broad aspect, when the number of successfully verified authentication factors is less than n, the selected subset of access rights is determined based both on the type of at least one successfully verified authentication factor and the number of successfully verified authentication factors.

These and other aspects and features of various embodiments will be described in greater detail below.

Some embodiments described herein make use of a mobile station. A mobile station is a two-way communication device with advanced data communication capabilities having the capability to communicate with other computer systems, and is also referred to herein generally as a mobile device. A mobile device may also include the capability for voice communications. Depending on the functionality provided by a mobile device, it may be referred to as a data messaging device, a two-way pager, a cellular telephone with data messaging capabilities, a wireless Internet appliance, or a data communication device (with or without telephony capabilities). A mobile device communicates with other devices through a network of transceiver stations.

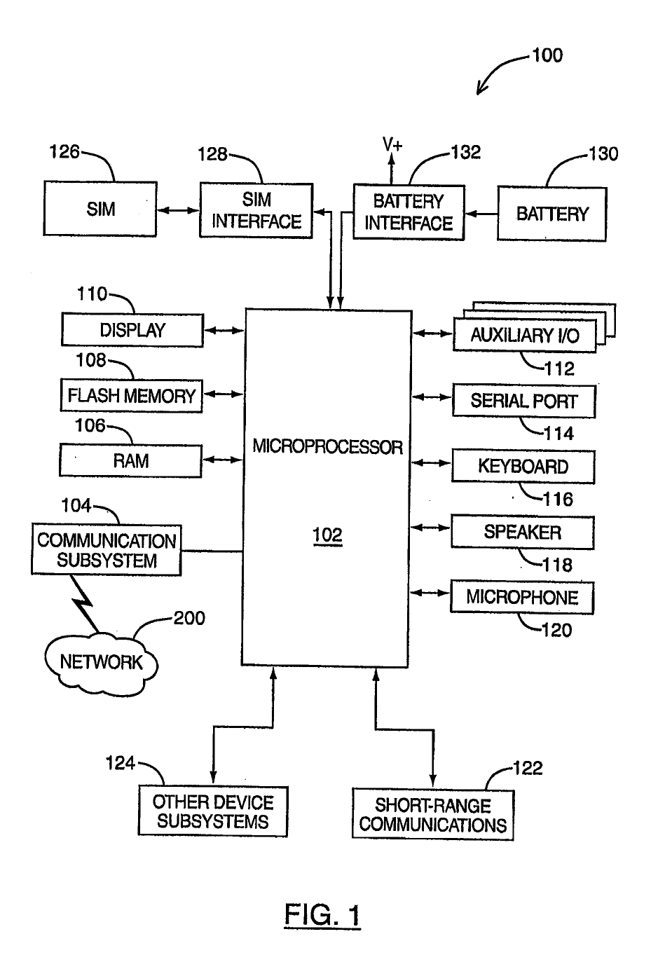

To aid the reader in understanding the structure of a mobile device and how it communicates with other devices, reference is made to FIGS. 1 through 3.

Referring first to FIG. 1, a block diagram of a mobile device in one example implementation is shown generally as 100. Mobile device 100 comprises a number of components, the controlling component being microprocessor 102. Microprocessor 102 controls the overall operation of mobile device 100. Communication functions, including data and voice communications, are performed through communication subsystem 104. Communication subsystem 104 receives messages from and sends messages to a wireless network 200. In this example implementation of mobile device 100, communication subsystem 104 is configured in accordance with the Global System for Mobile Communication (GSM) and General Packet Radio Services (GPRS) standards. The GSM/GPRS wireless network is used worldwide and it is expected that these standards will be superseded eventually by Enhanced Data GSM Environment (EDGE) and Universal Mobile Telecommunications Service (UMTS). New standards are still being defined, but it is believed that they will have similarities to the network behaviour described herein, and it will also be understood by persons skilled in the art that the embodiments of the present disclosure are intended to use any other suitable standards that are developed in the future. The wireless link connecting communication subsystem 104 with network 200 represents one or more different Radio Frequency (RF) channels, operating according to defined protocols specified for GSM/GPRS communications. With newer network protocols, these channels are capable of supporting both circuit switched voice communications and packet switched data communications.

Although the wireless network associated with mobile device 100 is a GSM/GPRS wireless network in one example implementation of mobile device 100, other wireless networks may also be associated with mobile device 100 in variant implementations. Different types of wireless networks that may be employed include, for example, data-centric wireless networks, voice-centric wireless networks, and dual-mode networks that can support both voice and data communications over the same physical base stations. Combined dual-mode networks include, but are not limited to, Code Division Multiple Access (CDMA) or CDMA2000 networks, GSM/GPRS networks (as mentioned above), and future third-generation (3G) networks like EDGE and UMTS. Some older examples of data-centric networks include the Mobitex™ Radio Network and the DataTAC™ Radio Network. Examples of older voice-centric data networks include Personal Communication Systems (PCS) networks like GSM and Time Division Multiple Access (TDMA) systems.

Microprocessor 102 also interacts with additional subsystems such as a Random Access Memory (RAM) 106, flash memory 108, display 110, auxiliary input/output (I/O) subsystem 112, serial port 114, keyboard 116, speaker 118, microphone 120, short-range communications subsystems 122 and other device subsystems 124.

Some of the subsystems of mobile device 100 perform communication-related functions, whereas other subsystems may provide “resident” or on-device functions. By way of example, display 110 and keyboard 116 may be used for both communication-related functions, such as entering a text message for transmission over network 200, and device-resident functions such as a calculator or task list. Operating system software used by microprocessor 102 is typically stored in a persistent store such as flash memory 108, which may alternatively be a read-only memory (ROM) or similar storage element (not shown). Those skilled in the art will appreciate that the operating system, specific device applications, or parts thereof, may be temporarily loaded into a volatile store such as RAM 106.

Mobile device 100 may send and receive communication signals over network 200 after required network registration or activation procedures have been completed. Network access is associated with a subscriber or user of a mobile device 100. To identify a subscriber, mobile device 100 provides for a Subscriber Identity Module or “SIM” card 126 to be inserted in a SIM interface 128 in order to communicate with a network. SIM 126 is one type of a conventional “smart card” used to identify a subscriber of mobile device 100 and to personalize the mobile device 100, among other things. Without SIM 126, mobile device 100 is not fully operational for communication with network 200. By inserting SIM 126 into SIM interface 128, a subscriber can access all subscribed services. Services may include without limitation: web browsing and messaging such as e-mail, voice mail, Short Message Service (SMS), and Multimedia Messaging Services (MMS). More advanced services may include without limitation: point of sale, field service and sales force automation. SIM 126 includes a processor and memory for storing information. Once SIM 126 is inserted in SIM interface 128, it is coupled to microprocessor 102. In order to identify the subscriber, SIM 126 contains some user parameters such as an International Mobile Subscriber Identity (IMSI). An advantage of using SIM 126 is that a subscriber is not necessarily bound by any single physical mobile device. SIM 126 may store additional subscriber information for a mobile device as well, including datebook (or calendar) information and recent call information.

Mobile device 100 may be a battery-powered device and may include a battery interface 132 for receiving one or more rechargeable batteries 130. Battery interface 132 may be coupled to a regulator (not shown), which assists battery 130 in providing power V+ to mobile device 100. Although current technology makes use of a battery, future technologies such as micro fuel cells may provide the power to mobile device 100. In some embodiments, mobile device 100 may be solar-powered.

Microprocessor 102, in addition to its operating system functions, enables execution of software applications on mobile device 100. A set of applications that control basic device operations, including data and voice communication applications, may be installed on mobile device 100 during its manufacture. Another application that may be loaded onto mobile device 100 is a personal information manager (PIM). A PIM has functionality to organize and manage data items of interest to a subscriber, such as, but not limited to, e-mail, calendar events, voice mails, appointments, and task items. A PIM application has the ability to send and receive data items via wireless network 200. PIM data items may be seamlessly integrated, synchronized, and updated via wireless network 200 with the mobile device subscriber's corresponding data items stored and/or associated with a host computer system. This functionality creates a mirrored host computer on mobile device 100 with respect to such items. This can be particularly advantageous where the host computer system is the mobile device subscriber's office computer system.

Additional applications may also be loaded onto mobile device 100 through network 200, auxiliary I/O subsystem 112, serial port 114, short-range communications subsystem 122, or any other suitable subsystem 124. This flexibility in application installation increases the functionality of mobile device 100 and may provide enhanced on-device functions, communication-related functions, or both. For example, secure communication applications may enable electronic commerce functions and other such financial transactions to be performed using mobile device 100.

Serial port 114 enables a subscriber to set preferences through an external device or software application and extends the capabilities of mobile device 100 by providing for information or software downloads to mobile device 100 other than through a wireless communication network. The alternate download path may, for example, be used to load an encryption key onto mobile device 100 through a direct and thus reliable and trusted connection to provide secure device communication.

Short-range communications subsystem 122 provides for communication between mobile device 100 and different systems or devices, without the use of network 200. For example, subsystem 122 may include an infrared device and associated circuits and components for short-range communication. Examples of short range communication include standards developed by the Infrared Data Association (IrDA), Bluetooth®, and the 802.11 family of standards developed by IEEE.

In use, a received signal such as a text message, an e-mail message, or web page download is processed by communication subsystem 104 and input to microprocessor 102. Microprocessor 102 then processes the received signal for output to display 110 or alternatively to auxiliary I/O subsystem 112. A subscriber may also compose data items, such as e-mail messages, for example, using keyboard 116 in conjunction with display 110 and possibly auxiliary I/O subsystem 112. Auxiliary subsystem 112 may include devices such as: a touch screen, mouse, track ball, infrared fingerprint detector, or a roller wheel with dynamic button pressing capability. Keyboard 116 may comprise an alphanumeric keyboard and/or telephone-type keypad. A composed item may be transmitted over network 200 through communication subsystem 104.

For voice communications, the overall operation of mobile device 100 is substantially similar, except that the received signals may be processed and output to speaker 118, and signals for transmission may be generated by microphone 120. Alternative voice or audio I/O subsystems, such as a voice message recording subsystem, may also be implemented on mobile device 100. Although voice or audio signal output is accomplished primarily through speaker 118, display 110 may also be used to provide additional information such as the identity of a calling party, duration of a voice call, or other voice call related information.

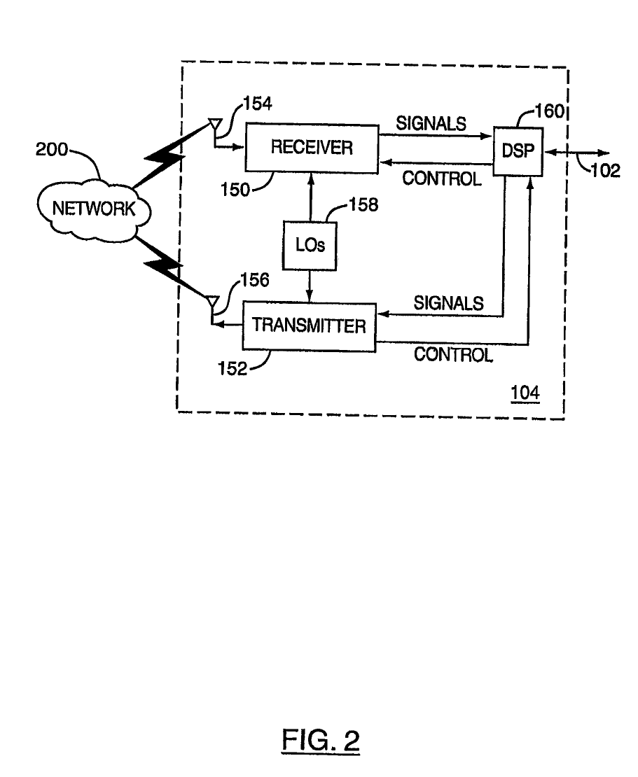

Referring now to FIG. 2, a block diagram of the communication subsystem component 104 of FIG. 1 is shown. Communication subsystem 104 comprises a receiver 150, a transmitter 152, one or more embedded or internal antenna elements 154, 156, Local Oscillators (LOs) 158, and a processing module such as a Digital Signal Processor (DSP) 160.

The particular design of communication subsystem 104 is dependent upon the network 200 in which mobile device 100 is intended to operate; thus, it should be understood that the design illustrated in FIG. 2 serves only as one example. Signals received by antenna 154 through network 200 are input to receiver 150, which may perform such common receiver functions as signal amplification, frequency down conversion, filtering, channel selection, and analog-to-digital (A/D) conversion. A/D conversion of a received signal allows more complex communication functions such as demodulation and decoding to be performed in DSP 160. In a similar manner, signals to be transmitted are processed, including modulation and encoding, by DSP 160. These DSP-processed signals are input to transmitter 152 for digital-to-analog (D/A) conversion, frequency up conversion, filtering, amplification and transmission over network 200 via antenna 156. DSP 160 not only processes communication signals, but also provides for receiver and transmitter control. For example, the gains applied to communication signals in receiver 150 and transmitter 152 may be adaptively controlled through automatic gain control algorithms implemented in DSP 160.

The wireless link between mobile device 100 and a network 200 may contain one or more different channels, typically different RF channels, and associated protocols used between mobile device 100 and network 200. A RF channel is a limited resource, typically due to limits in overall bandwidth and limited battery power of mobile device 100.

When mobile device 100 is fully operational, transmitter 152 may be typically keyed or turned on only when it is sending to network 200 and may otherwise be turned off to conserve resources. Similarly, receiver 150 may be periodically turned off to conserve power until it is needed to receive signals or information (if at all) during designated time periods.

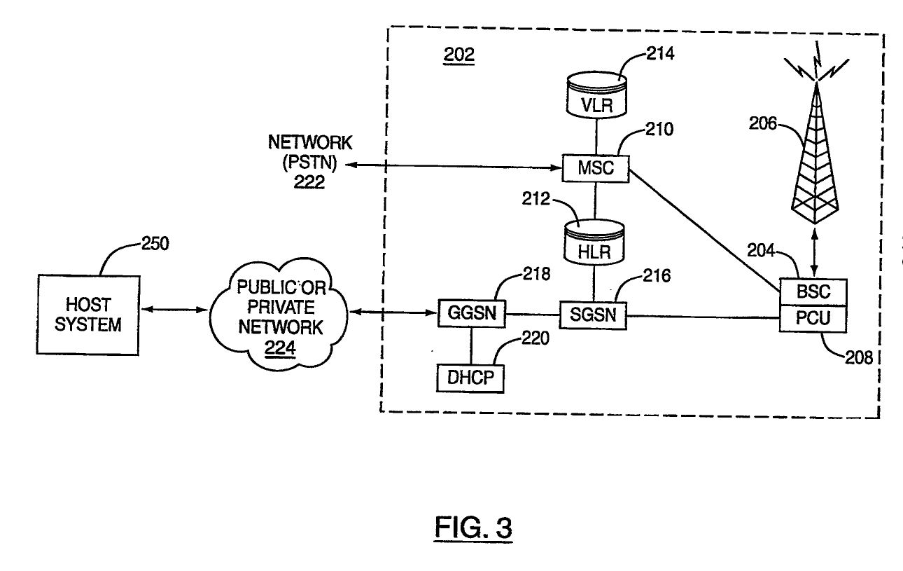

Referring now to FIG. 3, a block diagram of a node of a wireless network is shown as 202. In practice, network 200 comprises one or more nodes 202. Mobile device 100 communicates with a node 202 within wireless network 200. In the example implementation of FIG. 3, node 202 is configured in accordance with General Packet Radio Service (GPRS) and Global Systems for Mobile (GSM) technologies. Node 202 includes a base station controller (BSC) 204 with an associated tower station 206, a Packet Control Unit (PCU) 208 added for GPRS support in GSM, a Mobile Switching Center (MSC) 210, a Home Location Register (HLR) 212, a Visitor Location Registry (VLR) 214, a Serving GPRS Support Node (SGSN) 216, a Gateway GPRS Support Node (GGSN) 218, and a Dynamic Host Configuration Protocol (DHCP) 220. This list of components is not meant to be an exhaustive list of the components of every node 202 within a GSM/GPRS network, but rather a list of components that are commonly used in communications through network 200.

In a GSM network, MSC 210 is coupled to BSC 204 and to a landline network, such as a Public Switched Telephone Network (PSTN) 222 to satisfy circuit switched requirements. The connection through PCU 208, SGSN 216 and GGSN 218 to the public or private network (Internet) 224 (also referred to herein generally as a shared network infrastructure) represents the data path for GPRS capable mobile devices. In a GSM network extended with GPRS capabilities, BSC 204 also contains a Packet Control Unit (PCU) 208 that connects to SGSN 216 to control segmentation, radio channel allocation and to satisfy packet switched requirements. To track mobile device location and availability for both circuit switched and packet switched management, HLR 212 is shared between MSC 210 and SGSN 216. Access to VLR 214 is controlled by MSC 210.

Station 206 is a fixed transceiver station. Station 206 and BSC 204 together form the fixed transceiver equipment. The fixed transceiver equipment provides wireless network coverage for a particular coverage area commonly referred to as a “cell”. The fixed transceiver equipment transmits communication signals to and receives communication signals from mobile devices within its cell via station 206. The fixed transceiver equipment normally performs such functions as modulation and possibly encoding and/or encryption of signals to be transmitted to the mobile device in accordance with particular, usually predetermined, communication protocols and parameters, under control of its controller. The fixed transceiver equipment similarly demodulates and possibly decodes and decrypts, if necessary, any communication signals received from mobile device 100 within its cell. Communication protocols and parameters may vary between different nodes. For example, one node may employ a different modulation scheme and operate at different frequencies than other nodes.

For all mobile devices 100 registered with a specific network, permanent configuration data such as a user profile is stored in HLR 212. HLR 212 also contains location information for each registered mobile device and can be queried to determine the current location of a mobile device. MSC 210 is responsible for a group of location areas and stores the data of the mobile devices currently in its area of responsibility in VLR 214. Further VLR 214 also contains information on mobile devices that are visiting other networks. The information in VLR 214 includes part of the permanent mobile device data transmitted from HLR 212 to VLR 214 for faster access. By moving additional information from a remote HLR 212 node to VLR 214, the amount of traffic between these nodes can be reduced so that voice and data services can be provided with faster response times and at the same time requiring less use of computing resources.

SGSN 216 and GGSN 218 are elements added for GPRS support; namely packet switched data support, within GSM. SGSN 216 and MSC 210 have similar responsibilities within wireless network 200 by keeping track of the location of each mobile device 100. SGSN 216 also performs security functions and access control for data traffic on network 200. GGSN 218 provides internetworking connections with external packet switched networks and connects to one or more SGSN's 216 via an Internet Protocol (IP) backbone network operated within the network 200. During normal operations, a given mobile device 100 performs a “GPRS Attach” to acquire an IP address and to access data services. This normally is not present in circuit switched voice channels as Integrated Services Digital Network (ISDN) addresses are used for routing incoming and outgoing calls. Currently, all GPRS capable networks use private, dynamically assigned IP addresses, thus requiring a DHCP server 220 connected to the GGSN 218. There are many mechanisms for dynamic IP assignment, including using a combination of a Remote Authentication Dial-In User Service (RADIUS) server and DHCP server. Once the GPRS Attach is complete, a logical connection is established from a mobile device 100, through PCU 208, and SGSN 216 to an Access Point Node (APN) within GGSN 218. The APN represents a logical end of an IP tunnel that can either access direct Internet compatible services or private network connections. The APN also represents a security mechanism for network 200, insofar as each mobile device 100 must be assigned to one or more APNs and mobile devices 100 cannot exchange data without first performing a GPRS Attach to an APN that it has been authorized to use. The APN may be considered to be similar to an Internet domain name such as “myconnection.wireless.com”.

Once the GPRS Attach is complete, a tunnel is created and all traffic is exchanged within standard IP packets using any protocol that can be supported in IP packets. This includes tunneling methods such as IP over IP as in the case with some IPSecurity (Ipsec) connections used with Virtual Private Networks (VPN). These tunnels are also referred to as Packet Data Protocol (PDP) Contexts and there are a limited number of these available in the network 200. To maximize use of the PDP Contexts, network 200 will run an idle timer for each PDP Context to determine if there is a lack of activity. When a mobile device 100 is not using its PDP Context, the PDP Context can be deallocated and the IP address returned to the IP address pool managed by DHCP server 220.

At least some embodiments described herein are generally directed to a technique where access rights may be provided to a user based on successfully verified authentication factors that are received from a user, even where the user is unable to provide all the authentication factors typically required for access to the computing device. In a broad aspect, one or more authentication factors are provided by a user, and are received and verified by a security module application residing and executing on the computing device. When less than all of the authentication factors that would typically be required for authenticating a user for access to the computing device is received and successfully verified, a subset of the available access rights is selected from a plurality of different subsets of access rights and provided to the user. The specific access rights in the subset provided to the user are based on the successfully verified authentication factors.

In example embodiments described herein, the authentication factors subject to verification are user-specific. If a particular user requires access to a particular computing device (e.g. mobile device 100 of FIG. 1), he or she must provide the requisite authentication factors specifically associated with him or her. For example, a password that may be required in order for one user to be granted certain access rights will generally not be the same as the password that would be required for a different user to be granted the same access rights. This is in contrast to known systems (e.g. guest accounts) that may only require a generic login and/or password (or which may not require any login and/or password) that are not user-specific.

Generally, access rights grant a user of a computing device access to certain applications, resources, data, or other functionality on a computing device. The computing device may be configured to require that a user be provided with separate access rights associated with different applications, resources, data, or other functionality before access is granted.

For example, an access right associated with access to a network, such as a corporate network, government network, or home network, etc., may be provided to a user if the user is to be permitted such access. As a further example, a separate access right associated with highly confidential data stored on the computing device and/or on a network may be provided to a user only if the user is to be permitted access to such data. As a further example, a separate access right associated with message and/or data encryption and decryption functions may be provided to a user only if the user is to be permitted to perform such functions. As a further example, a separate access right associated with access to one or more particular peripheral devices (e.g. printers, fax machines), databases, disk drives, and/or other devices may be provided to a user only if the user is to be permitted such access. As a further example, a separate access right associated with one or more software applications may be provided to a user only if the user is to be permitted to execute such applications. It will be understood by persons skilled in the art that the access rights described above are provided by way of example only, and that other access rights may be defined in variant implementations. The manner in which access rights are defined may also differ in variant implementations. For example, in one system, permission to access confidential data stored on a computing device and permission to perform decryption functions (e.g. decrypting encrypted messages and/or encrypted data stored on the computing device) may be associated with two separate access rights (i.e. both, one, or none of the example access rights may be granted to a user), while in a different system, permission to access confidential data stored on the computing device and permission to perform decryption functions may be associated with a single access right (i.e. if the access right is granted, the user may access confidential data stored on the computing device as well as perform decryption functions).

As previously noted, in a controlled-access system, a user may be required to provide multiple authentication factors for user authentication. The authentication factors may comprise authentication data that originates from various sources and/or a physical element. For example, an authentication factor may comprise one or more of the following: a user name, a password, a smart card, a personal identification number (PIN), a biometric identifier (e.g. fingerprint, hand geometry data, retinal scan data, bone structure data, vein composition data, speech recognition data, etc.), data contained in a SIM card and the SIM card itself, data provided by a security token (e.g. Universal Serial Bus (USB) token, SecurID® token, or some other hardware token) and the presence of the physical token itself, a physical location (e.g. data obtained from a Global Positioning System or other device from which a geographical location can be determined), or other data and/or physical elements that may be used to authenticate a user as is known in the art or in accordance with after-arising technologies. Each mobile device user may be required to provide different authentication factors to obtain different access rights.

For ease of exposition, some embodiments are described herein in respect of mobile devices. However, it will be understood that embodiments described herein may also be implemented in respect of computing devices generally, and are not limited to mobile devices.

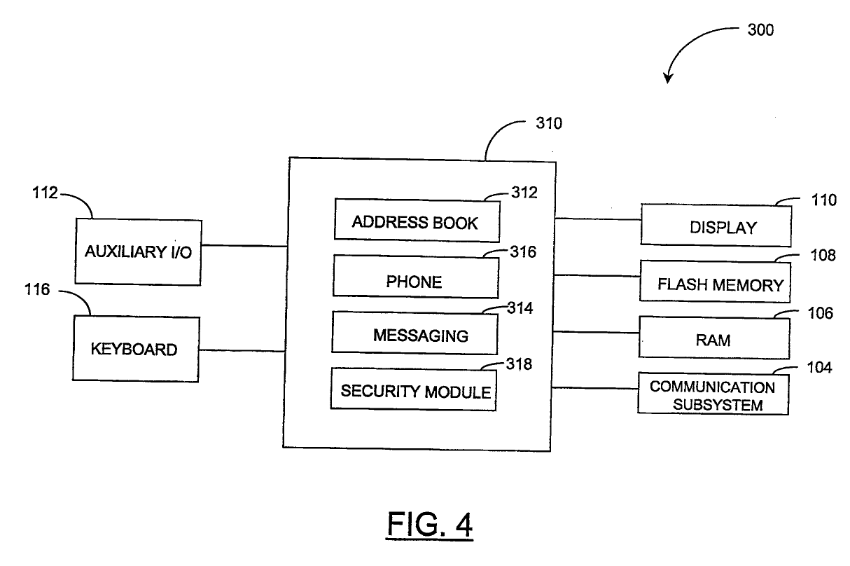

Referring now to FIG. 4, a block diagram illustrating further aspects of the mobile device of FIG. 1 in an example embodiment is shown generally as 300. As noted earlier with reference to FIG. 1, microprocessor 102, in addition to its operating system functions, enables execution of software applications on mobile device 100. A set of applications that control basic device operations, including data and voice communication applications, will normally be installed on mobile device 100 during its manufacture. Operating system software and other software applications are typically stored in a persistent store (e.g. flash memory 106) or other store, on mobile device 100 or on a device coupled thereto. It will be understood that the operating system, software applications or parts thereof, may be temporarily loaded in a volatile store such as RAM 106. Other instructions and/or data received by the mobile device 100 and subject to processing may also be temporarily stored in RAM 106.

Software applications that are loaded or stored on mobile device 100 may be implemented as functional components or modules 310. Modules 310 interact with various components of mobile device 100. For instance, as shown by way of example in FIG. 4, modules 310 may interact with communication subsystem 104, RAM 106, flash memory 108, display 110, auxiliary I/O device(s) 112, and keyboard 116. Modules 310 may comprise, for example, an address book module 312, a messaging module 314 (e.g. for e-mail and/or SMS or MMS messaging), a phone application module 316, and a security module 318.

Address book module 312 is generally configured to allow contact information (e.g. individual contact and company names, telephone numbers, messaging addresses, and other information) to be stored and managed. Messaging module 314 facilitates the sending and receiving of electronic messages over a wireless network 200 and/or other network.

Phone application module 316 is generally configured to facilitate voice communication between the user and other parties, including the placement of outgoing calls by the user and the reception of incoming calls on the mobile device 100.

Security module 318 is generally configured to receive and verify authentication data and/or a physical element (e.g. physical token, SIM card) associated with different types of authentication factors (e.g. from a user), and to determine what access rights may be granted to the user. Security module may receive authentication data and/or a physical element that is part of an authentication factor through, for example, keyboard 116 (e.g. user names, passwords, data read from security tokens) and/or auxiliary I/O device(s) 112 (e.g. biometric identification, security tokens). Security module 318 verifies received authentication factors, which may require verifying the presence of a physical element (e.g. a physical token, SIM card) and/or comparing the received authentication data associated with authentication factors being verified with data stored in a memory on the mobile device 100 (e.g. flash memory 108 or RAM 106 or other store) or in an external memory on a device, server and/or database connected thereto. In one example embodiment, verification of authentication factors requires comparing the received authentication data with data generated on the mobile device 100 in accordance with a key generating algorithm, for example.

For ease of exposition, authentication data associated with a particular authentication factor may be referred to generally herein in the specification and in the claims as an “authentication factor”. As previously noted, in some instances, authentication data and a physical element may, in combination, form an authentication factor (e.g. data provided by a security token and the presence of the token itself.

Typically, in the operation of a controlled-access computing device, such as a mobile device, users will be provided with unrestricted access, or access associated with a predetermined level of access, only upon successful verification of some fixed number of authentication factors. In this case, example embodiments described herein permit users to be provided with fewer access rights with less than the fixed number of authentication factors. Therefore, even if the user does not possess all authentication factors to obtain unrestricted access or access associated with the predetermined level of access at a particular time, but is able to provide some of the required authentication factors, user access may be limited to a selected subset of access rights based on the authentication factors that can be provided by the user. It is no longer necessary to lock out the user completely, or limit access to one pre-defined set of restricted access rights that would be provided with a guest account.

More generally, in operation of a multi-factor controlled-access computing device (e.g. a mobile device) in accordance with example embodiments, the device is configured to provide users with m access rights only upon successful verification of n authentication factors (where m and n are integers greater than 1). In one example embodiment, the set of available access rights may be linked to the computing device or may be specific to the user, or both. In accordance with example embodiments described herein, if at least one authentication factor is successfully verified and the number of successfully verified authentication factors is less than n, then a selected subset of access rights is determined from a plurality of different subsets of access rights. The access rights in the selected subset may be provided to the user.

In at least one embodiment described herein, the plurality of different subsets of access rights will comprise more than one subset that consists of less than m access rights. However, one or more subsets of the plurality of different subsets may consist of m access rights. For example, the plurality of different subsets of access rights may comprise a subset consisting of m access rights (“unrestricted access”), a subset consisting of zero access rights (“no access”), and at least one intermediate subset consisting of more than one but less than m access rights (“restricted access”).

Limitations on user access, namely the particular access rights and/or the number of access rights to be provided to a user that comprise the selected subset of a plurality of different subsets of access rights, are decided dynamically, and are dependent on the authentication factors that are successfully verified. More specifically, these limitations may be dependent on the specific authentication factors that have been successfully verified, the number of authentication factors that have been successfully verified, the type of at least one of the authentication factors that has been successfully verified, or some combination of the foregoing factors, for example.

In at least one example embodiment, a weight factor is associated with each of the n authentication factors, and an access score is determined. The access score is a function of the weight factors associated with those authentication factors that have been successfully verified. The selected subset of the m access rights that is provided to the user is based on the access score.

In one example embodiment, the specific selected subset of the different subsets of access rights that is provided to the user based on the access score is determined in accordance with a predefined schedule, the data of which may be stored in the form of one or more tables. The determination may also be made on the basis of predefined rules, or one or more algorithms, for example, in variant embodiments. The schedule, rules, or algorithms may be specific to a particular computing device, or may be specific to a particular user, or both, in variant embodiments. The schedule, rules, or algorithms may be implemented on a computing device by way of a security policy (e.g. an IT policy) governing use of the computing device, or through an administrative console, in variant embodiments.

By way of example, consider the following schedule:

| | Contribution to |
|---|---|
| Authentication factor | Access Score |
| Fingerprint | 10 |
| Smart card & associated PIN | 5 |
| User name & associated password | 5 |
| Subsets of Access Rights | Access Score |
| 1. Full access to local and | 20 |
| network resources | |
| 2. Full access to local and | 10-15 |
| network resources, except | |
| confidential data stores on network | |
| 3. Access to local resources only | 5 |
| 4. No access | 0 |

The above example illustrates that in certain implementations, the plurality of different subsets of access rights may be defined so that more than one combination of authentication factors may result in the same selected subset of access rights being selected (e.g. as a result of defining a range in access scores corresponding to a particular subset of access rights).

By way of a further example, consider the following alternative schedule:

| | Contribution to |
|---|---|
| Authentication factor | Access Score |
| Fingerprint | 20 |
| Smart card & associated PIN | 10 |
| User name & associated password | 5 |
| Subsets of Access Rights | Access Score |
| 1. Full access to local and | 35 |
| network resources | |
| 2. Full access to local and | 30 |
| network resources, except | |
| confidential data stores on network | |
| 3. Access to local resources only | 25 |
| 4. No access | <25 |

The above example indicates how the weight factors and schedules may be defined in such a way that assumes that the biometric authentication factor (e.g. the fingerprint) can be provided by the user, and that the specific subset of access rights that may be selected will depend on which of the other authentication factors, if any, can be provided by the user and successfully verified.

The foregoing examples are merely two examples presented to illustrate that the user's access is limited dynamically depending on the authentication factors provided by the user at the time the access request is made, and where the authentication factors are successfully verified. By defining weight factors in association with authentication factors, certain types of authentication data (e.g. biometric identifiers) may be given greater weight, particularly if it is more difficult for that data to be forged by a third party. It will be understood by persons skilled in the art that the above example is provided as an illustration only, and that the authentication factors, contributions to the access score, the different subsets of access rights that may be granted and the corresponding access scores can be defined differently depending upon the specific implementation.

In at least one further example embodiment, the selected subset of the different subsets of m access rights that is provided to the user is based solely on the number of successfully verified authentication factors. In one example embodiment, the specific selected subset that is provided to the user based on the number of successfully verified authentication factors is determined in accordance with a predefined schedule, which may be stored in the form of one or more tables. The determination may also be made on the basis of predefined rules, or one or more algorithms, for example, in variant embodiments. The schedule, rules, or algorithms may be specific to a particular computing device, or may be specific to a particular user, or both, in variant embodiments. The schedule, rules, or algorithms may be implemented on a computing device by way of a security policy (e.g. an IT policy) governing use of the computing device, or through an administrative console, in variant embodiments.

By way of example, consider the following schedule:

Authentication factors
Fingerprint
Smart card & associated PIN
User name & associated password

| | Number of Successfully |
|---|---|
| | Verified Authentication |
| Subsets of Access Rights | Factors |
| 1. Full access to local and | 3 |
| network resources | |
| 2. Full access to local and | 2 |
| network resources, except | |
| confidential data stores on network | |
| 3. Access to local resources only | 1 |
| 4. No access | 0 |

This example illustrates that the user's access is limited dynamically depending on the number of authentication factors provided by the user at the time the access request is made, and where the authentication factors are successfully verified. In this manner, the greater the number of authentication factors that a user can correctly provide, the fewer the number of limitations that will be placed on the user's access. It will be understood by persons skilled in the art that the above example is provided as an illustration only, and that the authentication factors, the different subsets of access rights that may be granted and the corresponding number of successfully verified authentication factors can be defined differently depending upon the specific implementation.

In at least one further example embodiment, the selected subset of the plurality of different subsets of m access rights that is provided to the user is based on the type of at least one successfully verified authentication factor. In one example embodiment, the specific selected subset that is provided to the user based on the type of at least one successfully verified authentication factor is determined in accordance with a predefined schedule, which may be stored in the form of one or more tables. The determination may also be made on the basis of predefined rules, or one or more algorithms, for example, in variant embodiments. The schedule, rules, or algorithms may be specific to a particular computing device, or may be specific to a particular user, or both, in variant embodiments. The schedule, rules, or algorithms may be implemented on a computing device by way of a security policy (e.g. an IT policy) governing use of the computing device, or through an administrative console, in variant embodiments.

By way of example, consider the following schedule:

Authentication factors identified by type
Biometric identifier: Fingerprint
Device carried by user: Smart card & associated PIN
Information known to user: User name & associated password

| | Required Successfully |
|---|---|
| | Verified Authentication |
| Subsets of Access Rights | Factors |
| 1. Full access to local and | at least a biometric |
| network resources | identifier (e.g. fingerprint) |
| | & device carried by user |
| | (e.g. smart card & PIN) |
| | & information known to |
| | user (e.g. user name & |
| | password) |
| 2. Full access to local and | at least a biometric |
| network resources, except | identifier (e.g. fingerprint) |
| confidential data stores | & device carried by user |
| on network | (e.g. smart card & PIN) |
| 3. Access to local resources only | at least information known |
| | to user (e.g. user name |
| | & password) |
| 4. Access to network resources only | a biometric identifier |
| | (e.g. fingerprint) |
| | or device carried by user |
| | (e.g. smart card & PIN) |
| 5. No access | no successfully verified |
| | authentication factors |

This example illustrates that the user's access is limited dynamically depending on the types of authentication factors (e.g. biometric identifiers, authentication factors based on a device carried by the user, authentication factors based on information known to the user) provided by the user at the time the access request is made, and where the authentication factors are successfully verified. By determining access based on the type of an authentication factor, certain types of authentication data (e.g. biometric identifiers) may be associated with higher levels of access, particularly if it is more difficult for that data to be forged by a third party. It will be understood by persons skilled in the art that the above example is provided as an illustration only, and that the authentication factors, the different subsets of access rights that may be granted and the corresponding types of successfully verified authentication factors that are required for access can be defined differently depending upon the specific implementation.

The above examples are provided by way of illustration only, and it will be understood that different schedules, rules, or algorithms may be customized and applied in respect of a given implementation. It will be understood by persons skilled in the art that a combination of the example schedules described above may be used to determine the selected subset of m access rights that are provided to the user. For example, in a variant embodiment, the selected subset of m access rights provided to the user is based on the type of at least one successfully verified authentication factor as well as the number of successfully verified authentication factors. Other combinations and variations are possible.

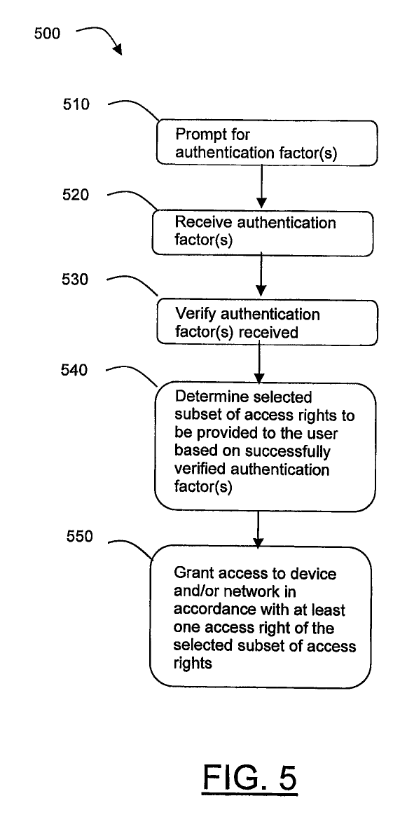

Some of the features of the embodiments described above, and of other features and other embodiments will be described in further detail with reference to FIG. 5.

Referring to FIG. 5, a flow chart illustrating a method of controlling user access to a computing device in accordance with at least one embodiment is shown generally as 500. Additional details of some of the features described below in respect of method 500 may be described earlier in the present specification.

In at least one embodiment, method 500 may be performed at a mobile device (e.g. mobile device 100) by a security module (e.g. security module 318 of FIG. 4) that resides on the mobile device. It will be understood that the method may be implemented on other computing devices, such as a computer, but for simplicity, method 500 may be described herein with reference to a mobile device. Method 500 need not be implemented in a stand-alone application, and the functionality described herein may be implemented in one or more application modules executed and residing on the mobile device 100 or on another device connected thereto via a network.

At step 510, a user requesting access to mobile device 100 is prompted to provide one or more required authentication factors in order to be granted access rights. The prompt may be implemented in various ways as known in the art. For example, a dialog box may be displayed to the user on a display (e.g. display 110 of FIG. 1) of the mobile device 100. The user is prompted to provide one or more authentication factors, as may be required for unrestricted access for example. As another example, a speaker (e.g. speaker 118 of FIG. 118) may deliver an audio prompt indicating that the user should provide one or more authentication factors. As another example, the prompt may be a haptic prompt, such as a vibrating prompt. In addition, the prompt may be a combination of visual, audio, and/or haptic prompts.

Step 510 may be performed in response to a user-initiated event, such as for example: when the user powers on their mobile device 100, or indicates a desire to unlock their mobile device. As a further example, the user may be prompted for authentication factors when the user attempts to access certain functionality of the mobile device 100 where access is controlled, and for which they have not yet been granted access. For example, this may occur when the user initiates an outgoing phone call, attempts to access a network, or when the user activates a phone application or other software application.

In one embodiment, while operating the device, a user may manually activate the dialog box that prompts the user to provide the one or more required authentication factors. For example, the user may direct that an authentication factor options menu be displayed on the display 110 of the mobile device 100 by, for example, selecting an options or menu icon or key. An authentication factor options menu may list the various required authentication factors to the user, and the user may make a selection from the list (e.g. by depressing a navigation tool such as a mouse, track ball, track wheel, or pre-programmed key) to trigger a corresponding dialog box that prompts the user for the associated authentication factor.

It will be appreciated by persons skilled in the art that step 510 is optional, and authentication data may be retrieved from some sources without the aid of a user prompt. For example, a user may have inserted a SIM card with authentication data stored thereon into a SIM interface (e.g. SIM interface 128 of FIG. 1), such that the authentication data may be automatically retrieved by security module 318 when required. The authentication data retrieved from the SIM card and the SIM card itself form the authentication factor being verified, in this example.

At step 520, one or more authentication factors are received from the user (e.g. authentication data is received and/or a physical element is detected), as may have been provided by the user in response to the prompt generated at step 510, for example.

In certain multi-factor controlled access systems, up to n authentication factors (n is an integer greater than 1) can be received at the device, in order to provide the user with m access rights (m is an integer greater than 1). In some embodiments, m represents the maximum number of access rights that can be provided to a user (“unrestricted access” or “highest access level”). However, in some situations, the user may only be able to provide k authentication factors, where k is less than n, n being the number of required authentication factors in order to be granted all m access rights.

For example, if three authentication factors (e.g., a user name and associated password, a smart card and associated PIN, and a thumbprint) are required for the user to be granted m access rights, at step 520, only two of the three (e.g. the user name and associated password, and the thumbprint) might be received from the user at a particular time. For example, the user might not have the smart card in his or her possession at the time that access is desired, but nonetheless the user would like some limited degree of access to the mobile device 100.

It will be appreciated that any of a number of suitable authentication factors known in the art may be received from the user through various components internal to the device and/or through various components connected to the device. For instance, a user may enter a user name and/or password using keyboard 116, provide a speech sample using microphone 120, or provide biometric information using an auxiliary I/O device 112 comprising a biometric data detector, for example.

In variant embodiments, more than one user may be required to provide authentication factors for access. For example, fingerprint scans from different individuals may be required for access.

In variant embodiments, an authentication factor may not be received directly from a user, but from some other device, memory, computer, or other component. For example, a user may have inserted a SIM card with authentication data stored thereon into a SIM interface (e.g. SIM interface 128 of FIG. 1), and the authentication data may then be automatically retrieved by security module 318 from the SIM card when required. The authentication data retrieved from the SIM card and the SIM card itself comprise the authentication factor being verified, in this example.

At step 530, the security module 318 verifies the authentication factors received at step 520. For example, the security module 318 may be configured to detect the presence of a physical element (e.g. a physical token, SIM card) and/or access data required for verification, stored locally on the mobile device (e.g. flash memory 108 or RAM 106), stored remotely from the mobile device (e.g. a database or memory accessible to the device via communication subsystem 104, network 200 or serial port 114), or generated by an algorithm, for example.

For each authentication factor where authentication data is to be verified, the security module 318 compares the respective authentication data with the stored or generated data used for verification, and if a match is determined, the respective authentication factor may be considered to be successfully verified. If a match is not determined, the authentication factor is not considered to be successfully verified.

For example, a password and an associated username may be stored locally on a list, database, or other store of valid authentication factors (e.g. a password store). If the password provided by the user does not match the password stored on the list of valid authentication factors, then the user name and password will not successfully verify. As another example, if the authentication factor comprises a fingerprint scan, and the fingerprint data input by the user does not match the stored fingerprint data against which scanned fingerprints are to be verified for access, then the fingerprint provided by the user will not successfully verify. As another example, if the authentication factor comprises a physical location, data from a Global Positioning System or similar device must match data identifying an expected location in order for the authentication factor to successfully verify.

In some embodiments, the authentication factors will be user-specific. For example, a user profile may be associated with a user and either stored internally on mobile device 100 or on an external memory connected thereto. The user profile may contain data used for verification of all authentication factors associated with that specific user, and the security module 318 may verify authentication factors provided by the user using the user profile and the data for the authentication factors therein.

In some embodiments, the user may be re-prompted for an authentication factor, or an error message may be displayed to the user, when an authentication factor does not successfully verify (step not explicitly shown).

In some instances, verifying an authentication factor may also require verifying detection of a physical element (e.g. authentication data provided by a physical token must be successfully verified, and the presence of that physical token must also be detected).

At step 540, the security module 318 determines the access rights that are to be provided to the user based on the authentication factors successfully verified at step 530. A selected subset from a plurality of different pre-defined subsets of access rights each comprising zero or more access rights (up to and including m) may be provided to the user at this step. The plurality of different subsets of access rights comprises more than one subset consisting of less than m access rights. If at least one authentication factor is successfully verified and the number of successfully verified authentication factors equals n, all m access rights are provided to the user. However, if at least one authentication factor is successfully verified but the number of successfully verified authentication factors is less than n, then a subset is selected from the different pre-defined subsets and provided to the user. Typically, when the number of successfully verified authentication factors is less than n, then the selected subset will be one that consists of less than m access rights. However, it is possible that the selected subset will consist of m access rights in such a scenario, depending on the particular schedule, rules, or algorithms being implemented.

As noted earlier in the present specification, the selected subset of the m access rights provided to the user at step 540 may be based on a computed access score, on the number of successfully verified authentication factors, on the type of at least one successfully verified key, or on some combination of the above, in example embodiments. For example, the security module 318 may have access to a schedule, rules, or algorithms (e.g. the schedules, rules or algorithms described above) which may be stored locally on the mobile device 100 or may be stored remotely on a network, server and/or database connected thereto, in order to determine the selected subset of m access rights provided to the user at step 540 based on a computed access score, on the number of successfully verified authentication factors, on the type of at least one successfully verified key, or on some combination of the above, in example embodiments.

In some embodiments, the subset of access rights may be referred to as an access level, where each access level corresponds to a predetermined subset of access rights. For example, three access levels may be associated with the mobile device 100 and/or a user. A first access level may correspond to a subset of two specific access rights, namely making outgoing calls and receiving incoming calls. A second access level may correspond to a subset of three access rights, namely the two named above and accessing an Intranet network. A third access level may correspond to a subset of five access rights, namely the three named above and read/write access to a calendar and read/write access to a contact list. A user may be granted access to the mobile device 100 in accordance with one of these access levels, depending on the number and/or type of successfully verified authentication factors, for example.

Where different subsets of access rights are defined as different access levels, the different access levels may be organized in a hierarchical structure. For example, the “highest” access level may represent unrestricted access (e.g. including access to highly confidential data), with lower access levels representing varying degrees of restrictions that are arranged in a hierarchy in which greater restrictions on access are assessed at the lowest access levels. However, in variant implementations, the different pre-defined subsets of access rights may comprise various different combinations of access rights that would not be considered to define levels in a hierarchy.

The plurality of pre-defined different subsets of access rights may be defined by an administrator. For example, the association between the number and/or type of successfully verified authentication factors and the access rights that may be provided to a user accordingly may be configured by an administrator, in accordance with a security policy (e.g. IT Policy) or through an administrative console, for example, in variant embodiments. Such configuration may also be performed or modified by a user, for example, in variant embodiments.

At step 550, the security module 318 grants the user access to the mobile device 100 in accordance with one or more access rights of the selected subset of access rights provided to the user at step 540. The granting of access to the mobile device 100 at this step may be in response to a user request. The access rights provided to the user may permit the user to access certain functionality of the mobile device 100. For example, a user may place an outgoing phone call on a mobile device 100, or may access a secure Intranet via network 200 when provided with the appropriate access rights.

In variant embodiments, at least some steps of method 500 may be repeated at various times throughout the user's session (i.e. the period of time that the user is using or attempting to use the mobile device 100), in order to re-authenticate the user. If the re-authentication is not successful, one or more access rights previously granted may be rescinded.

In variant embodiments, at least some steps of method 500 may be repeated to allow the user to request additional access during a user's session. For example, if a user could not initially provide the security token necessary to obtain unrestricted access, but possesses it later during the user's session, the user may provide it to obtain a higher level of access.

In variant embodiments, one or more access rights may be rescinded during a user's session. This may or may not affect the level of access available to the user at the time such access rights are rescinded. For example, a user may remove a smart card or a security token from a device interface during the user's session. The security module 318 may be configured to dynamically adjust the level of access to which the user is granted in this case while the user is still engaged in the session, if desired. For instance, if the user is granted access to a network after the smart card is inserted, network access may be terminated upon removal of such smart card. Alternatively, network access may still be granted even upon removal of the smart card, until some event occurs requiring re-authentication of the user (e.g. locking of mobile device 100).

The method of controlling access to a computing device in accordance with any of the embodiments described herein may be provided as executable software instructions stored on computer-readable media, which may include transmission-type media.

The method of controlling access to a computing device (e.g. mobile device 100) in accordance with any of the embodiments described herein may be provided as a system comprising at least a processor and a memory, wherein the system is configured to execute the security module 318 in order to perform the method.

As used herein, the wording “and/or” is intended to represent an inclusive-or. That is, “X and/or Y” is intended to mean X or Y or both. Moreover, “X, Y, and/or Z” is intended to mean X or Y or Z or any combination thereof.

The invention has been described with regard to a number of embodiments. However, it will be understood by persons skilled in the art that other variants and modifications may be made without departing from the scope of the invention as defined in the claims appended hereto.

1. A method of controlling access to a computing device, wherein in operation, m access rights associated with the computing device are provided only upon successful verification of n authentication factors, where m and n are integers greater than 1, the method comprising:
receiving one or more authentication factors required for access to the computing device;
verifying each of the one or more authentication factors received;
if at least one authentication factor is successfully verified and the number of successfully verified authentication factors equals n, providing m access rights; and
if at least one authentication factor is successfully verified and the number of successfully verified authentication factors is less than n,
determining a selected subset of access rights from a plurality of different subsets of access rights, wherein the plurality of different subsets of access rights comprises more than one subset consisting of less than m access rights, and
providing the selected subset of access rights.

2. The method of claim 1, wherein the selected subset of access rights consists of less than m access rights.

3. The method of claim 1, wherein a weight factor is associated with each of the n authentication factors, and wherein the method further comprises:
determining an access score to determine the selected subset, the access score being a function of the weight factors associated with the successfully verified authentication factors, wherein the selected subset of access rights is determined based on the access score.

4. The method of claim 1, wherein when the number of successfully verified authentication factors is less than n, the selected subset of access rights is determined based on the number of successfully verified authentication factors.

5. The method of claim 1, wherein when the number of successfully verified authentication factors is less than n, the selected subset of access rights is determined based on the type of at least one successfully verified authentication factor.

6. The method of claim 1, wherein when the number of successfully verified authentication factors is less than n, the selected subset of access rights is determined based both on the type of at least one successfully verified authentication factor and the number of successfully verified authentication factors.

7. The method of claim 1, wherein the selected subset of access rights is determined in accordance with a predefined schedule.

8. The method of claim 7, wherein the predefined schedule is user-specific.

9. The method of claim 7, wherein the predefined schedule is defined through an administrative console.

10. The method of claim 1, wherein the selected subset of access rights is determined in accordance with a plurality of predefined rules.

11. The method of claim 10, wherein the plurality of predefined rules is user-specific.

12. The method of claim 10, wherein the plurality of predefined rules is defined through an administrative console.

13. The method of claim 1, wherein the selected subset of access rights is determined in accordance with a security policy governing use of the computing device.

14. The method of claim 1, further comprising prompting for at least one authentication factor.

15. The method of claim 1, further comprising granting access to the computing device in accordance with at least one of the selected subset of access rights.

16. The method of claim 1, wherein each of the n authentication factors comprises one or more of the following: user name, password, smart card, PIN, security token, biometric identifier, SIM card, physical location.

17. The method of claim 1, wherein the computing device comprises a mobile device.

18. The method of claim 1, wherein at least one of the m access rights is associated with a network accessible by the computing device.

19. A computer-readable medium comprising instructions executable on a processor of a computing device for implementing a method of controlling access to the computing device, wherein in operation, m access rights associated with the computing device are provided only upon successful verification of n authentication factors, where m and n are integers greater than 1, the method comprising:
receiving one or more authentication factors required for access to the computing device;
verifying each of the one or more authentication factors received;
if at least one authentication factor is successfully verified and the number of successfully verified authentication factors equals n, providing m access rights; and
if at least one authentication factor is successfully verified and the number of successfully verified authentication factors is less than n,
determining a selected subset of access rights from a plurality of different subsets of access rights, wherein the plurality of different subsets of access rights comprises more than one subset consisting of less than m access rights, and
providing the selected subset of access rights.

20. A system for controlling access to a computing device, the system comprising at least a processor and a memory, wherein in operation, m access rights associated with the computing device are provided only upon successful verification of n authentication factors, where m and n are integers greater than 1, wherein the system is configured to execute a security module programmed to perform acts comprising:
receiving one or more authentication factors required for access to the computing device;
verifying each of the one or more authentication factors received;
if at least one authentication factor is successfully verified and the number of successfully verified authentication factors equals n, providing m access rights; and
if at least one authentication factor is successfully verified and the number of successfully verified authentication factors is less than n,
determining a selected subset of access rights from a plurality of different subsets of access rights, wherein the plurality of different subsets of access rights comprises more than one subset consisting of less than m access rights, and
providing the selected subset consisting of less than m access rights.

21. The system of claim 20, wherein the computing device comprises a mobile device.

22. An access-controlled mobile device, wherein in operation, m access rights associated with the mobile device are provided only upon successful verification of n authentication factors, where m and n are integers greater than 1, wherein the mobile device comprises at least a processor and a memory, and wherein the mobile device further comprises a security module executable by the processor, the security module programmed to perform acts comprising:
receiving one or more authentication factors required for access to the mobile device;
verifying each of the one or more authentication factors received;
if at least one authentication factor is successfully verified and the number of successfully verified authentication factors equals n, providing m access rights; and
if at least one authentication factor is successfully verified and the number of successfully verified authentication factors is less than n,
determining a selected subset of access rights from a plurality of different subsets of access rights, wherein the plurality of different subsets of access rights comprises more than one subset consisting of less than m access rights, and
providing the selected subset consisting of less than m access rights.
